(19) United States
(12) Patent Application Publication
(10) Pub. No.: US 2004/0135806 A1
(43) Pub. Date: Jul. 15, 2004

(54) Method for modifying groups of data fields in a web environment

(76) Inventors: Craig Pickering, Alpharetta, GA (US); Gregory D. Pickering, Atlanta, GA (US)

Correspondence Address: Gregory Scott Smith, P.O. Box 88148, Atlanta, GA, 30356, US

(21) Appl. No.: 10/341,769

(22) Filed: Jan. 14, 2003

(51) Int. Cl. G09G 5/00

(52) U.S. Cl. 345/760; 345/780

(57) ABSTRACT

A method for adding a data field or a plurality of data fields to a group of at least one data field is described, illustrated and claimed. The novel system and method allows for quick and efficient addition of a data field or a plurality of data fields to a group of at least one data field, while preserving the characteristics of the group of at least one data field. The invention operates in a markup language environment and provides flexibility and expandability in a data entry interface.

### TECHNICAL FIELD

The present invention relates to control interfaces for computer programs and, more particularly to a method for modifying a group of data fields in a web environment.

### BACKGROUND OF THE INVENTION

Computer users have become accustomed to using web-based computer software applications that present information through a graphical user interface. A number of methods for presenting information have become de facto standards. For instance, radio buttons, checkboxes, slide bars, pushbuttons and data fields are used throughout the industry. These items are referred to as graphical user interface objects, or graphical objects. A user typically interacts with web-based software applications having a graphical user interface by moving a pointer or cursor over a graphical object using, for example, a mouse or similar pointing device such as a light pen, or by using the Tab key, and then indicating (for example, by clicking a mouse button, pressing the light pen or entering data) that the object should be selected. Alternatively, some graphical user interfaces may be presented on a touch-sensitive display screen. In that situation, the user interacts with the software application by touching the graphical object he wishes to select.

The programmer writing a web-based software application having a graphical user interface defines the physical layout of the graphical objects on the user interface screen, as well as the function, if any, to be associated with the objects and any logical relationships among those objects. The function represented by a graphical object can be as simple as displaying data, or it can represent a more complex function such as initiating the execution of a software subroutine, or any other function desired by the programmer.

One type of a graphical object is a data field, or a graphical user interface form into which a particular item of data can be entered. A data field can exist in a variety of formats but typically applications utilize a blank text box, an empty line, or other indicia. These indicia are presented to a user or operator by on a computer display or screen. The field provides a window or input interface for a user or operator to enter data into a database, a running program or other type of register for storing or operating on the data and/or for displaying the data on a computer screen.

Data fields often are used in web-based applications such as data entry forms, registration pages, online purchases and the like. In such web-based applications, the fields are typically presented to the user within a window displayed on the user's computer screen. For example, in a WINDOWS EXPLORE operating environment, a window containing a tabulated listing of the data can be displayed. Windows are graphical interface components that present objects and actions to computer operators. Windows are presented to operators by way of a computer display or screen. A window in effect allows a user or operator to see an image of an application or web page that has been constructed by the computer. For the purposes of this application, a window will be referred to as a generic view of at least a portion of a data field as opposed to the term of art associated with a window. Thus, a window can be created by any web-based computer application running any software package and can take on many forms and formats.

Data fields within a web-based window on a computer display are used for a variety of purposes, including, but not limited to: entering item information, entering quantity information, entering ordering information, entering address information, entering contact numbers, entering search terms, attaching files, etc. For example, when placing an order on a web-based window, a group of data fields may be presented to the user for entering ordering data. The number and types of data fields can vary depending on the particular application. In an application, a user may be requested, prompted or allowed to enter an item name into a data field designated for items. Then, the user may be prompted to enter a quantity into a data field designated for quantity of the item. Next, depending on the particular web page, a user may be prompted to enter a color for the item in a data field designated for color of the item. Finally, the user may finish the order for that item in some manner, such as clicking a check-out button. If a user wants to select multiple items to be purchased, the user typically must complete this entire process for each item. For items that include several fields, this process can be quite time consuming. It would be very beneficial to have a way to modify a group of data fields for entering multiple items at one time without resetting the group of data fields and going through the entire process again.

What is needed, therefore, is a solution that allows a user to enter more than one piece of data into a group of data fields without having to restart or reset the entire process.

### SUMMARY OF THE INVENTION

In general, the present invention can be described as a novel system and method for quickly and efficiently modifying groups of data fields or display groups. More specifically, performing an action (i.e. depressing Enter, etc.), associated with a rule, modifies a display group of at least one data field. The action can include any of a variety of actions, such as, depressing the Enter key, depressing the Shift key and the Enter key, depressing the Ctrl key and the “A” key, clicking on a mouse, etc. The operation can include any of a variety of operations, such as, adding a data field, adding a tabulated data field, adding a tabulated and sub-grouped data field, or the like. Using the tabulated data field example, in a group of at least one tabulated data field consisting of data field tabulated as “1”, when an action is performed in said data field, the group will be modified to consist of said data field tabulated as “1” and a new data field tabulated as “2”.

An object of the present invention is to provide a technique for quickly and efficiently modifying a group of at least one data field, while adding a data field and preserving the characteristics of the group.

Another object of the present invention is to provide a technique for quickly and efficiently modifying a group of at least one data field, with simple articulation.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a system diagram that illustrates an exemplary environment suitable for implementing various embodiments of the present invention.

FIG. 2 is an exemplary application utilizing an embodiment of the present invention.

FIG. 3 is a flow diagram illustrating the method of an exemplary embodiment of the present invention as perceived by a computing device.

FIGS. 4A-B illustrate an aspect in which the objects used by the present invention may be depicted on a graphical user interface display of a computer workstation.

FIGS. 5A-B illustrate another aspect in which the objects used by the present invention may be depicted on a graphical user interface display of a computer workstation.

### DETAILED DESCRIPTION

In general, the present invention can be described as a novel system and method for quickly and efficiently modifying a group of at least one data field displayed in a web environment by a computer device in response to simple actions performed by a user or process. Some examples of data fields include, but are not limited to: graphical user interface objects, database fields, data objects, textual objects, etc. As with the exemplary embodiments below, these examples are for illustrative purposes only and, a person skilled in the art will construe them broadly.

Referring now to the figures, in which like numerals refer to like elements throughout the several views, exemplary embodiments of the present invention are described. Throughout the detailed description, reference will be made to the operation of the present invention when embodied within a computing device within a web-based environment. Computing devices may include, but are not limited to, personal computers, mainframe computers, servers, and any other device capable of executing the software associated with the present invention. It should be understood that the features and aspects of the present invention can be ported into a variety of systems and system/network configurations and any examples provided within this description are for illustrative purposes only.

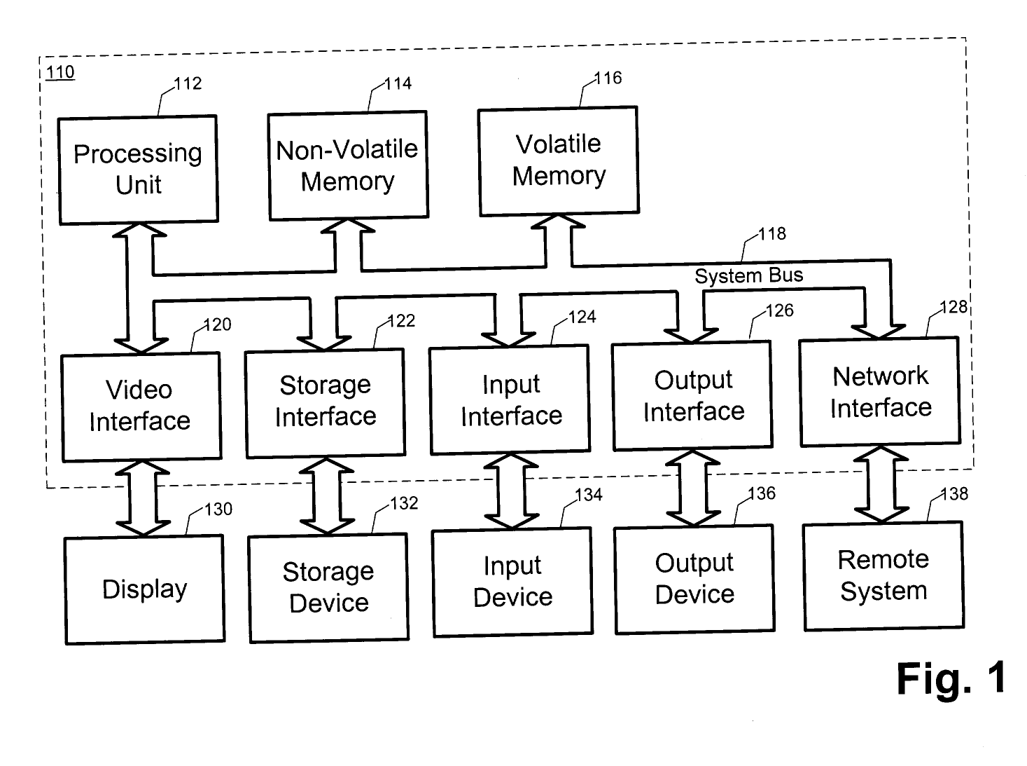

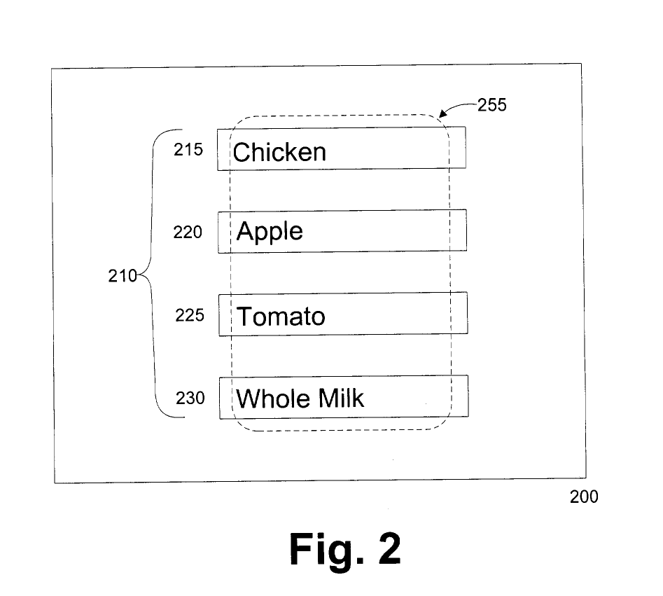

In conjunction with FIG. 1, the components of a general platform on to which aspects of the present invention can be implemented are described. Next, exemplary embodiments of the present invention are illustrated in conjunction with FIGS. 2-5.

Exemplary Environment

FIG. 1 is a system diagram that illustrates an exemplary environment suitable for implementing various embodiments of the present invention. FIG. 1 and the following discussion provide a general overview of a platform onto which the invention, or portions thereof, may be integrated, implemented and/or executed. Although in the context of the exemplary environment the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 1 may take on many forms and may be directed towards performing a variety of functions. Generally, the system illustrated in FIG. 1 may be any system that includes a computer processor. Examples of such forms and functions include, but are not limited to, personal computers, hand-held devices such a personal data assistants, note-book computers, lap-top computers, mainframe computers, servers and a variety of other applications, each of which may serve as an exemplary environment for embodiments of the present invention.

The exemplary system illustrated in FIG. 1 includes a computing device 110 that is made up of various components including, but not limited to a processing unit 112, non-volatile memory 114, volatile memory 116, and a system bus 118 that couples the non-volatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 114 provides storage for power on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic random access memory (DRAM), FLASH memory, EEPROM, bubble memory, registers, or the like. The volatile memory 116 provides temporary storage for routines, modules, functions, macros, data, etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain in tact, whereas the contents of the volatile memory 116 are lost, corrupted, or erased.

The computing device 110 may access one or more external display devices 130 such as a CRT monitor, LCD panel, LED panel, electro-luminescent panel, or other display device, for the purpose of providing information or computing results to a user. In some embodiments, the external display device 130 may actually be incorporated into the product itself. The processing unit 112 interfaces to each display device 130 through a video interface 120 coupled to the processing unit 110 over the system bus 118.

The computing device 110 may interface with one or more storage devices such as a hard disk drive, a compact disk drive, a floppy disk drive, a RAM drive or other memory drive, for the purpose of storing information, program data or programs. The storage device 132 is accessed through a storage interface 122 that connects to the system bus 118.

The computing device 110 may send output information, in addition to the display 130, to one or more output devices 136 such as a speaker, modem, printer, plotter, facsimile machine, RF or infrared transmitter, computer or any other of a variety of devices that can be controlled by the computing device 110. The processing unit 112 interfaces to each output device 136 through an output interface 126 coupled to the processing unit 112 over the system bus 118. The output interface 126 may include one or more of a variety of interfaces, including but not limited to, cable modems, DLS, T1, V series modems, an RS-232 serial port interface or other serial port interface, a parallel port interface, a universal serial bus (USB), a general purpose interface bus (GPIB), an optical interface such as infrared or IRDA, an RF or wireless interface such as Bluetooth, or other interface.

The computing device 110 may receive input or commands from one or more input devices 134 such as a keyboard, pointing device, mouse, modem, RF or infrared receiver, microphone, joystick, track ball, light pen, game pad, scanner, camera, computer or the like. The processing unit 112 interfaces to each input device 134 through an input interface 124 coupled to the processing unit 112 over the system bus 118. The input interface 124 may include one or more of a variety of interfaces, including but not limited to, cable modems, DSL, T1, V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

It will be appreciated that program modules implementing various embodiments of the present invention may be stored in the non-volatile memory 114, the volatile memory 116, or in a remote memory storage device accessible through the output interface 122 and the input interface 124. The program modules may include an operating system, application programs, other program modules and program data. The processing unit 112 may access various portions of the program modules in response to the various instructions contained therein, as well as under the direction of events occurring or being received over the input interface 124.

The computing device 110 may interface with one or more remote systems 138, such as a server or client, through a network interface 128. In a networked configuration, some or all of the components of the present invention may be distributed and operate on one or more remote systems 138. The present invention may be embodied in a web application that is assessable on a remote system 138 through a browser type application running on processing unit 112.

Components of a Typical Screen

FIG. 2 is a “screen shot” 200 in a web environment that illustrates an exemplary embodiment of the present invention. Generally, the screen shot illustrated in FIG. 2 may be any screen that includes data fields. Examples of such forms and functions that a screen may be displayed on include, but are not limited to, personal computers, hand-held devices such a personal data assistants, note-book computers, lap-top computers, mainframe computers, servers and a variety of other applications, each of which may serve as an exemplary environment for embodiments of the present invention.

More particularly, the screen shot 200 in FIG. 2 includes a plurality of data fields 210 with associated data 255. The plurality of data fields 210 are depicted individually and defined by numerals 215 to 230. The associated data 255 can be any type of data or even a graphical element.

Operations of Exemplary Embodiments

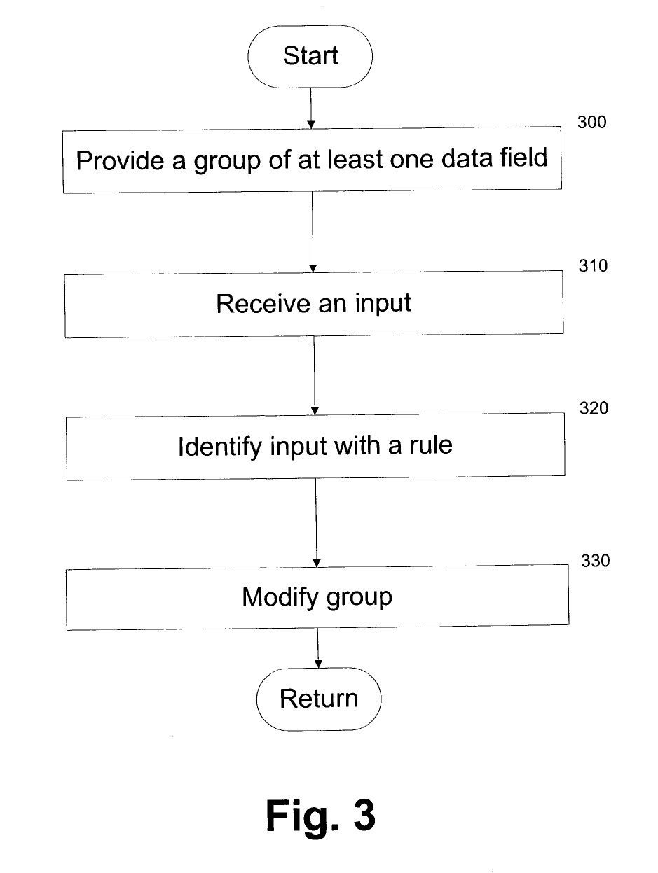

The exemplary embodiments of the present invention will now be discussed with reference to FIGS. 3-5.

For illustrative purposes, the present invention will be described using logically-defined groups of graphical user interface data fields, these examples are for illustrative purposes only and, a person skilled in the art will construe them broadly.

The present invention illustrates a markup language based software application that presents graphical data fields that have been physically and logically grouped by a programmer writing the software application. The graphical data field used may be a data field, or it may be some other type of graphical data field used to represent the function described herein as being associated with a data field.

One aspect of the present invention allows for quick and efficient modification of a logically-defined group of at least one graphical user interface data field, by performing an action (i.e. depressing Enter, depressing Enter while holding the Shift key down, double clicking a mouse or equivalent button while the mouse pointer is over a particular data field, etc.) associated with a rule. As an example, a user may perform an action to associate one of the data fields of the logically-defined group of at least one graphical user interface data field with a rule. In this example, a data field within the group contains a cursor or mouse pointer, wherein the cursor or mouse pointer indicates a data insertion point. Data can be inserted at the data insertion point; however, data insertion is not required for an action to be performed. The data insertion point associates the particular data field and group containing the data field to a rule when an action is performed. Then, a rule is identified for the associated data field and group. Next, an operation is performed according to the rule (i.e. adding a new data field). At that point, if the user wishes, he can enter data into the new data field or he can perform another action to create another data field within the group.

FIG. 3 illustrates the logical steps performed by a markup language based computer application embodying the present invention. It will be obvious to one skilled in the art how to incorporate the processes of FIG. 3 into a larger process for handling general interactions with a graphical user interface.

The process of using the present invention begins at Step 300, where a computer provides a group of at least one data field according to FIG. 3. Next, the computer receives an input, such as an expansion input to create a new data field (i.e. Enter, Enter Shift, double click of a mouse, etc.) from a user or another process at Step 310. The input will be associated with the group of at least one data field and a data field within the group. Next, based on the input, the computer identifies a rule to be applied to the group at Step 320. Finally, the computer modifies the group in accordance with the rule at Step 330.

The flexibility of the present invention allows for the mapping of multiple data fields to multiple rules. Thus, the speed and efficiency of applying certain operations to groups of data fields can be customized depending on the application. In any particular embodiment of the present invention, one or more data fields can be mapped to one or more rules using a one to one mapping, many to one mapping or one to many mapping.

The inputs, or actions performed by the user, process or an application program may include, but are not limited to, the following types of actions: depressing the Enter key, depressing the Enter key while holding down the Shift key, depressing the Enter key while holding down the Ctrl key, double clicking a mouse or equivalent button while the mouse pointer is over a particular data field, clicking a mouse or equivalent button while the Shift key is being held down, clicking a mouse or equivalent button while the Ctrl key is held down, pressing and holding a mouse or equivalent button for a certain period of time, triple clicking a mouse or equivalent button, clicking a mouse or equivalent button while the Alt key is being held down, depressing the “A” key or equivalent key while the Shift key is being held down, depressing the “A” key or equivalent key while the Ctrl key is being held down, etc.

When an input or action is performed, a rule is identified. The rule generally involves associating an operation with the appropriate group and data field. The rule is generally determined by the action performed by the user, process or an application program.

Once the appropriate rule is identified, the operation is performed on the appropriate group or data field, thus, modifying the group or data field. Some examples of modifications include, but are not limited to: adding a data field to the group, adding a tabulated data field to the group, adding a tabulated sub-group to the group and modifying a data field into a sub-group, etc.

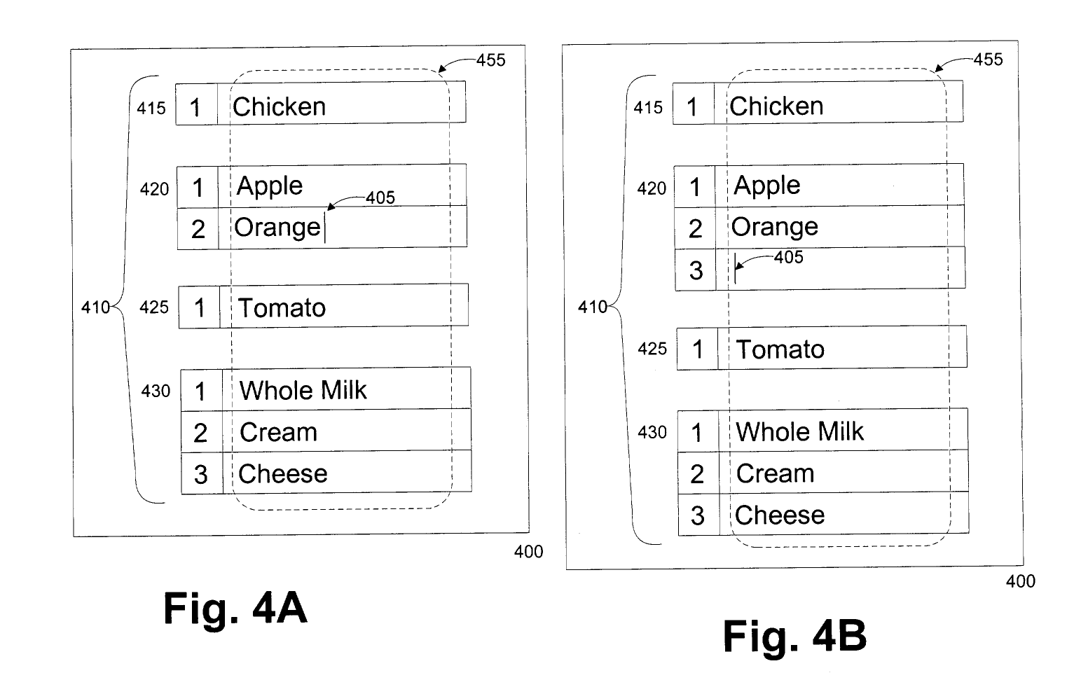

FIGS. 4A-B depict an exemplary embodiment of the present invention illustrating the aforementioned actions and rules. The actions or inputs are only for illustrative purposes and one skilled in the art would construe them broadly and not limiting. In addition, the association of the action/rule combination as well as the actions and rules themselves are only for illustrative purposes and one skilled in the art would construe them broadly and not limiting. In FIG. 4A, for example, a screen shot 400 depicts a plurality of groups of at least one data field 410 in tabulated format and its associated text 455. The plurality of groups are defined individually as 415-430. A cursor 405 is located in group 420. Upon performing an action, such as depressing the Enter key, a rule is invoked, (i.e. adding a tabulated data field). The results of this operation are shown in FIG. 4B with a tabulated data field added to group 420. Note that in this example the cursor 405 moves into the added data area to facilitate quick data entry.

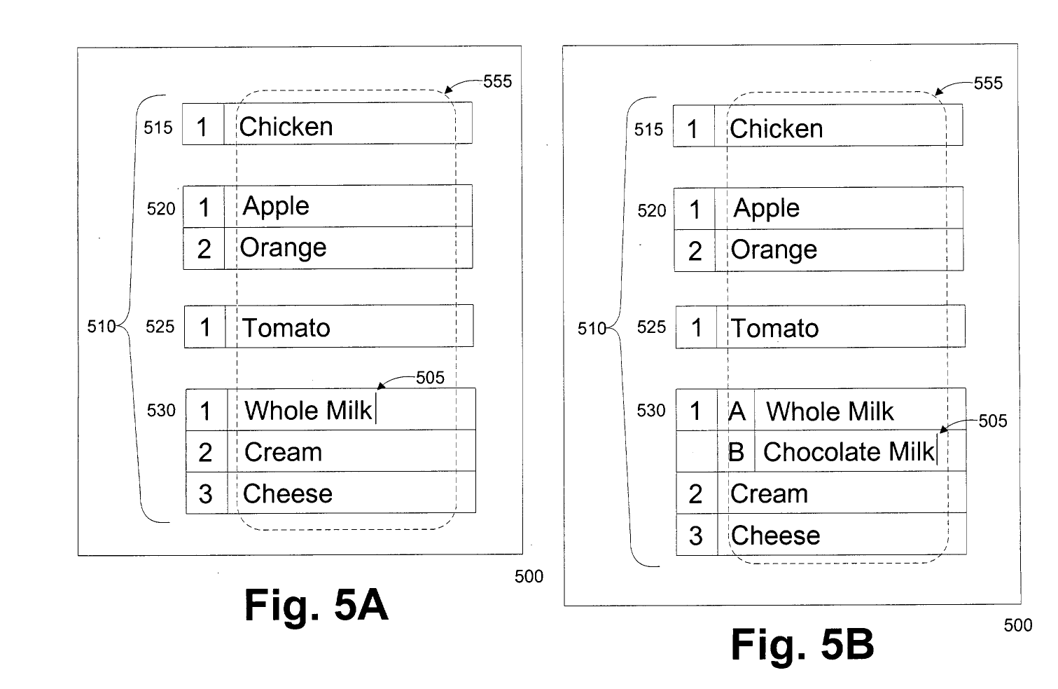

FIGS. 5A-B depict an exemplary embodiment of the present invention illustrating the aforementioned actions and rules. In FIG. 5A, for example, a screen shot 500 depicts a plurality of groups of at least one data field 510 in tabulated format and its associated text 555. The plurality of groups are defined individually as 515-530. A cursor 505 is located in group 530. Upon performing an action, such as depressing the Enter key while holding down the Ctrl key, a rule is invoked, (i.e. adding a tabulated sub-group data field and modifying a data field into a sub-group). The results of this operation are shown in FIG. 5B with a tabulated sub-group data field added to group 530 and the first data field within the group 530 modified into a sub-group. Note that in this example the letters: “C-h-o-c-o-l-a-t-e- -M-i-l-k” have been inserted and the cursor 505 is displayed after the newly entered letters.

The underlying database that the data is stored into, or the processing of the data can be accomplished in a variety of manners and the present invention is not limited to any particular application, processing or storing technique for the data. For instance, in a database environment, as new data fields are created through the operation of the present invention, it may be necessary to alter the structure of the database for housing the new data. Those skilled in the art will be very familiar with techniques for implementing such solutions.

One skilled in the art will appreciate that the application of the present invention can take many forms and function and the examples provided herein are only used to illustrate a few of these possibilities. The scope of the present invention is not limited by these examples.

Although this disclosure describes our invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for adding data fields in a markup language based environment, comprising the steps of:
providing a display group of at least one markup language based text box; and
in response to receiving an input, adding an additional markup language based text box to said display group.

2. The method of claim 1, wherein the step of providing a display group comprises the steps of:
displaying a first markup language based text box; and
receiving a data entry into said first markup language based text box.

3. The method of claim 1, wherein the step of adding an additional data field to said display group comprises the steps of:
receiving an input while a pointing device is located within the first markup language based text box;
creating an additional markup language based text box that has an association with the first text box; and
displaying the additional text box.

4. The method of claim 3, further comprising the step of receiving a data entry into said additional text box.

5. The method of claim 3, further comprising the steps of:
tabulating said first markup language based text box, wherein said first markup language based text box will be the first item in a sequentially ordered group; and
tabulating said additional markup language text box, wherein said additional markup language based text box will be associated with said sequentially ordered group.

6. A method for displaying a display group in a markup language based environment, comprising the steps of:
providing said display group, wherein said group is comprised of a plurality of data fields operable to receive data into each data field;
receiving an expansion input when a cursor is located within one of said data fields; and
in response to said expansion input, modifying said display group to include an additional data field.

7. The method of claim 6, wherein the step of modifying said display group comprises the steps of:
tabulating said data field where said cursor is located, wherein said data field where said cursor is located will be the first item in a sequentially ordered group; and
tabulating said additional data field, wherein said data field will be associated with said sequentially ordered group.

8. A system for displaying data fields in a markup language based environment, comprising:
an input means;
a display device;
a memory storage device containing a program module; and
a processing unit coupled to the input means, the display device and the memory storage device, the processing unit, in response to instructions in the program module, being operative to:
display a group of text boxes on said display device, the group of text boxes including at least one markup language based text box;
in response to receiving a particular pointer motion from the input means, displaying a pointing element in a particular one of the text boxes in the group of text boxes; and
in response to receiving an expansion input from the input means, adding an additional markup language based text box to said group of text boxes.

9. The system of claim 8, wherein the processing unit is operative to display a group of text boxes by:
displaying a first markup language based text box; and
receiving a data entry into said first markup language based text box.

10. The system of claim 8, wherein the processing unit is operative to add an additional data field to said display group by:
receiving the expansion input while the pointing element is located within the particular text box;
creating an additional markup language based text box that has an association with the first text box; and
displaying the additional text box.

11. The system of claim 10, wherein the processing unit is further operative to receive a data entry into said additional text box.

12. The system of claim 10, wherein the processing unit is further operative to:
tabulate said first markup language based text box, wherein said first markup language based text box will be the first item in a sequentially ordered group; and
tabulate said additional markup language text box, wherein said additional markup language based text box will be associated with said sequentially ordered group.
